(19) United States
(12) Patent Application Publication
(10) Pub. No.: US 2026/0186324 A1
(43) Pub. Date: Jul. 2, 2026

(54) Eyeglasses with elastic hinges

(71) Applicant: LVMH Swiss Manufactures SA, La Chaux-de-Fonds (CH)

(72) Inventor: Renato MONTAGNER, Venezia (IT)

(73) Assignee: LVMH Swiss Manufactures SA, La Chaux-de-Fonds (CH)

(21) Appl. No.: 18/866,411

(22) PCT Filed: May 16, 2023
(86) PCT No.: PCT/EP2023/063201

§ 371 Date: Nov. 15, 2024

(30) Foreign Application Priority Data
May 17, 2022 (FR) 2204683

(51) Int. Cl. G02C 5/22

(52) U.S. Cl. CPC G02C 5/2254

(57) ABSTRACT

Eyeglasses with elastic hinges comprising two temples and a frame front which can bear lenses, where each temple extends along a longitudinal direction between a distal end far from the frame front and a proximal end connected to the frame front; the proximal end of the frame front comprises a flexible portion which has an inner surface arranged for being oriented towards the head of a user when the eyeglasses are worn. The eyeglasses further comprise, for each temple, an elastic insert which is removably attached near the inner surface of the flexible portion, where said elastic insert determines the tightness of the temples on the head of the user when the eyeglasses are worn.

### FIELD OF THE INVENTION

The present disclosure relates to eyeglasses with elastic hinges.

### DESCRIPTION OF RELATED ART

Eyeglasses having a frame front intended to bear lenses and two temples connected to the frame front by elastic hinges have been proposed. Such elastic hinges avoid the use of pivot hinges. They are generally configured for pushing the temples towards each other, gripping the head of the user when the eyeglasses are worn. Thus, the eyeglasses may engage firmly on the head of the user.

However, when the dimensions or the gripping of the eyeglasses are not well suited to the user, the pressure caused by the elastic hinges may generate uncomfortable pressure points on the head of the user.

Further, aging of the eyeglasses may generate a loss of elasticity in the elastic hinges, such that properly fitting the eyeglasses on the head of the user may worsen with time.

The goal of the present disclosure is in particular to remedy all or part of the aforementioned disadvantages.

### BRIEF SUMMARY OF THE INVENTION

For that purpose, eyeglasses are proposed with elastic hinges comprising two temples and a frame front which can bear lenses, where each temple extends along a longitudinal direction between a distal end far from the frame front and a proximal end connected to the frame front, and where the proximal end of the frame front comprises a flexible portion which has an inner surface arranged for being oriented towards the head of a user when the eyeglasses are worn, the eyeglasses further comprise, for each temple, an elastic insert which is removably attached near the inner surface of the flexible portion, wherein said elastic insert determines the tightness of the temples on the head of the user when the eyeglasses are worn.

In that way the insert may determine the flexibility of the flexible portions. When several inserts are available with different elastic characteristics, the eyeglasses may be adapted to different uses, to users having different head widths, or having different preferences, all while being comfortable and providing a good hold. Further, when the elastic insert ages and loses some of its elastic properties, it may be possible to replace it and thus extend the lifetime of the eyeglasses.

The characteristics disclosed in the following paragraphs may, optionally, be implemented independently of each other or in combination with each other:
the elastic insert is attached by push fitting in said flexible portion of the temple;
the elastic insert comprises a first tenon, a second tenon and a longitudinal body extending between the first tenon and the second tenon, where the first and second tenons are push fitted on either side of the flexible portion so as to be able to exert traction on the longitudinal body as the temples are separated from each other;
the first and second tenons are push fitted into cavities formed in the flexible portion;
the cavities are open towards the inner surface of the flexible portion;
each tenon comprises at least one shoulder extending towards the longitudinal body, engaged in a groove extending the corresponding cavity under a ledge of the corresponding temple;
a portion of each cavity is left free by the tenon so as to allow a sufficient displacement of the tenon in the cavity for freeing said shoulder from the corresponding groove;
near each cavity, the longitudinal body is received in a slot, where said slot is open towards the inner surface of the flexible portion, and where said slot extends along the longitudinal direction;
the flexible portion comprises an outer wall and a series of nubs projecting from said outer wall towards the inner surface, where said nubs are aligned along the longitudinal direction and respectively form teeth which extend parallel to the inner surface to delimit a channel, and where the insert can be press fitted in said channel;
all the teeth extend in the same direction, and the channel is open parallel to the inner surface;
the frame front comprises a curved portion extending between the temples and the temples extend in the continuation of the curved portion of the frame front, where the eyeglasses have a rounded shape adapted to tightening on the head of the user;
the frame front and the temples are a polyamide thermoplastic, and the insert is an elastomer.

### BRIEF DESCRIPTION OF THE DRAWINGS

Other characteristics, details and advantages will appear upon reading the following detailed description, and analyzing the attached drawings, on which:

FIG. 1 schematically shows a perspective view of an example of eyeglasses.

FIG. 2 schematically shows an exploded perspective view of the example of eyeglasses of FIG. 1.

FIG. 3 schematically shows a top view of the example of eyeglasses of FIG. 1.

FIG. 4 schematically shows a perspective view of a detail of a temple which may be used in the example of eyeglasses of FIG. 1.

FIG. 5 schematically shows a view of the detail of FIG. 4 from a different perspective.

FIG. 6 schematically shows a detail of FIG. 4.

FIG. 7 schematically shows a perspective view of an elastic insert which could be used in the eyeglasses of FIG. 1.

FIG. 8 schematically shows a perspective view of the detail of FIG. 4 with the elastic insert of FIG. 5.

FIG. 9 schematically shows a view of the detail of FIG. 4 from a different perspective with the elastic insert of FIG. 5.

FIG. 10 schematically shows a transverse section view of the detail of FIG. 4 with the elastic insert of FIG. 5.

### DETAILED DESCRIPTION OF THE INVENTION

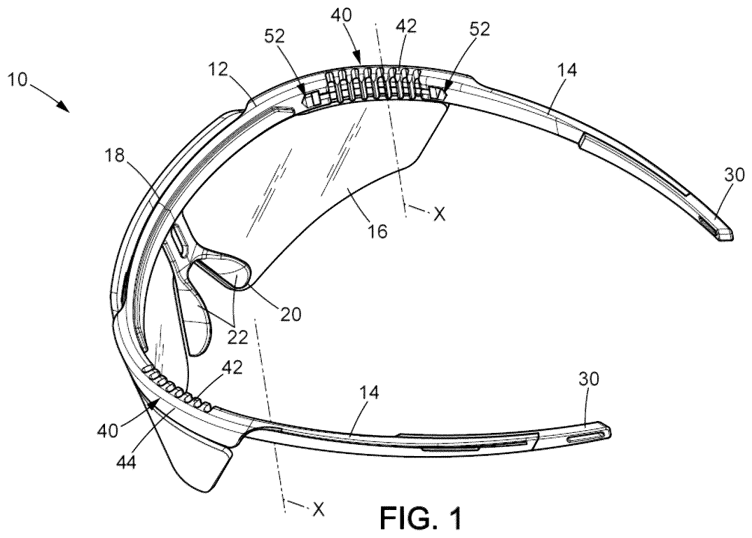

FIG. 1 schematically shows an example of eyeglasses 10. The eyeglasses 10 essentially comprise, as shown, a frame front 12 and two temples 14. The frame front 12 is intended to allow the attachment of the lenses 16. The lenses 16 may in particular be vision corrective lenses, lenses for protection against the sun or transparent lenses. The temples 14 extend on either side of the frame front 12 so the user can wear the eyeglasses 10.

The frame front 12 and temples 14 may here be formed as a single unit, making manufacturing of the eyeglasses 10 easier. The frame front 12 and the temples 14 such as described above are made of a stiff material, for example a polyamide thermoplastic. The material may for example be the Grilamid® brand product from the EMS-Grivory company.

Here, the frame front 12 may comprise a curved portion 18 connecting the two temples 14 and a nose pad 20 extending perpendicularly to the curved portion 18 substantially at the center of the curved portion 18. The curved portion 18 extends along the forehead of the user when the eyeglasses 10 are worn. The nose pad 20 may comprise two pad arms 22 giving it a substantially “Y” shape for engaging on the nose of the user.

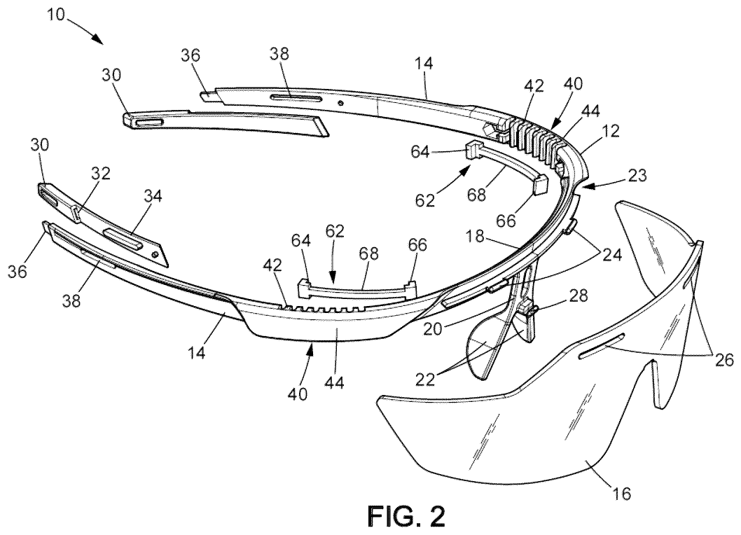

As can be seen better on FIG. 2, in the specific example shown, the curved portion 18 may comprise a receiving zone 23 for the lenses 16. Two projections 24 may project from the receiving zone 23 for engaging respectively in two openings 26 formed in the lenses 16. Further, the nose pad 20 may comprise a hook 28 open upwards, in which a lower edge of the lenses 16 may be inserted. After that, the lenses 16 may be attached to the frame front 12 by push fitting the edge of the lenses 16 in the hook 28 of the nose pad 20 and by insertion of the openings 26 of the lenses 16 in the projections 24 of the frame front 12. The lenses 16 are thus removable and can easily be replaced, in the example considered.

Each temple 14 extends along a longitudinal direction from the frame front 12. Each temple 14 has a proximal end connected to the frame front 12 and a distal end intended to be located near the ears of the user when the eyeglasses 10 are worn.

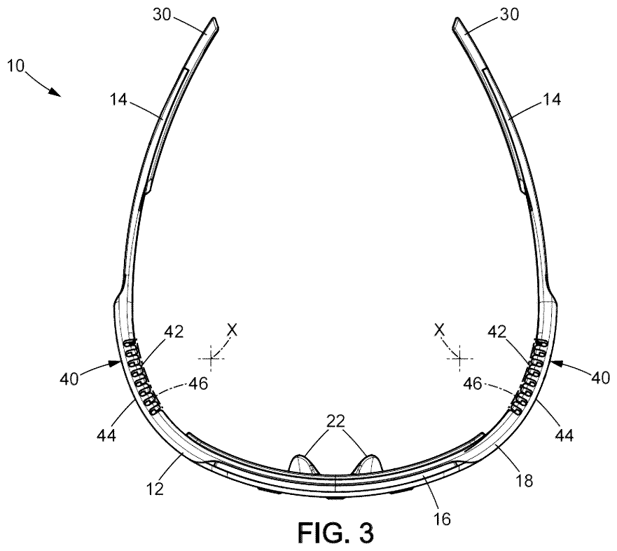

Here, the temples 14 extend substantially curved towards the inside of the eyeglasses 10 meaning towards the head of the user when the eyeglasses 10 are worn. The curvature of the temples 14 contributes to exerting a pressure on the head of the user for assuring the proper fit of the eyeglasses 10. Here, each temple 14 extends in the continuation of the curved portion 18 of the frame front 12. Thus, seen from above (see FIG. 3), the eyeglasses 10 have a substantially rounded shape suited for gripping the head of a user.

A tip 30 may be attached to the distal end of each temple 14 so it extends in the extension of the temples 14. The tips 30 are intended to rest on the ears of the user. The tips 30 may be an elastomer to increase the comfort of the user when the eyeglasses 10 are worn. The tip 30 may comprise a housing 32 and a groove 34 intended to engage with a tab 36 and a rib 38 formed on each temple 14.

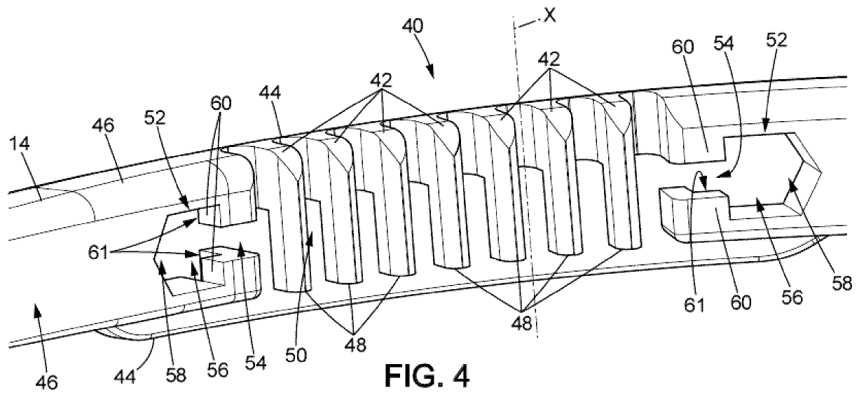

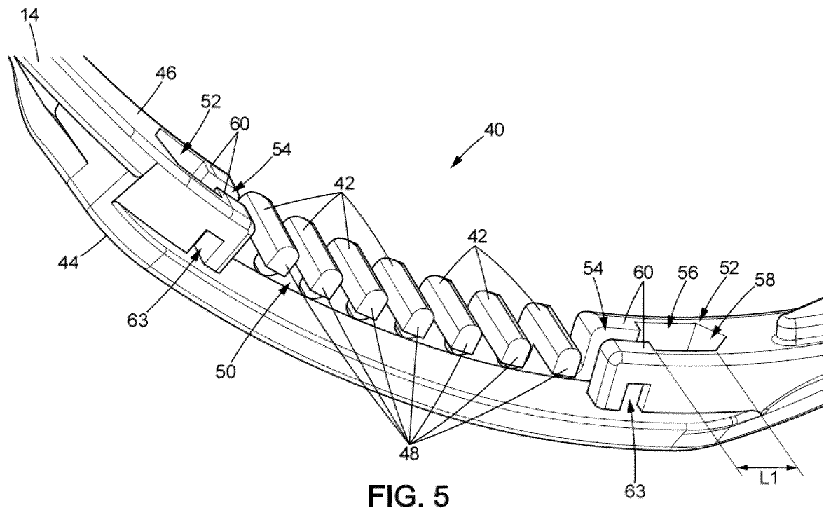

As can be seen better on FIGS. 4 and 5, the proximal end of each temple 14, near the frame front 12, has a flexible portion 40. The flexible portion 40 forms an elastic hinge allowing the temples 14 to turn relative to the frame front 12, substantially around an axis of rotation X. The flexible portion 40 urges the temples 14 towards the interior of the eyeglasses 10 allowing the temples 14 to elastically bear on either side of the head of the user.

Here the flexible portion 40 comprises a series of nubs 42 aligned along the longitudinal direction of the corresponding temple 14. The nubs 42 project from an outer wall 44 of the flexible portion 40 opposite the head of the user when the eyeglasses 10 are worn, towards an inner surface 46 of the flexible portion 42 facing the head of the user when the eyeglasses 10 are worn. The free spaces separating the nubs 42 give a flexibility to the flexible portion 40.

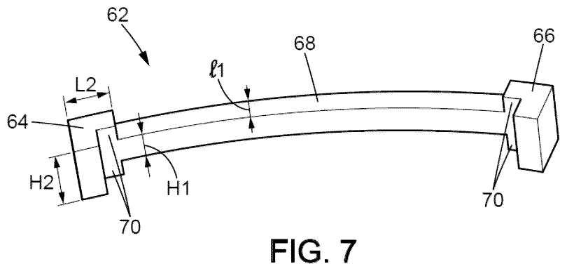

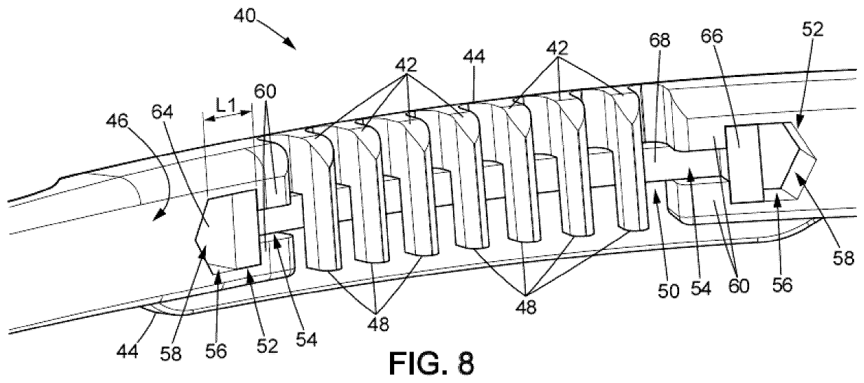

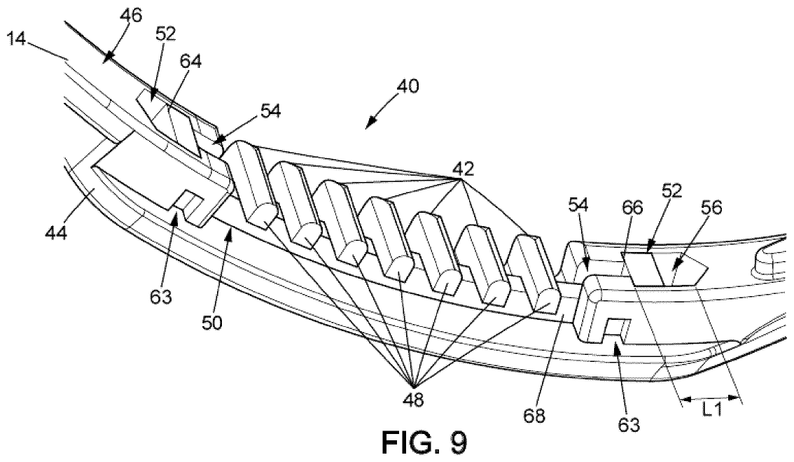

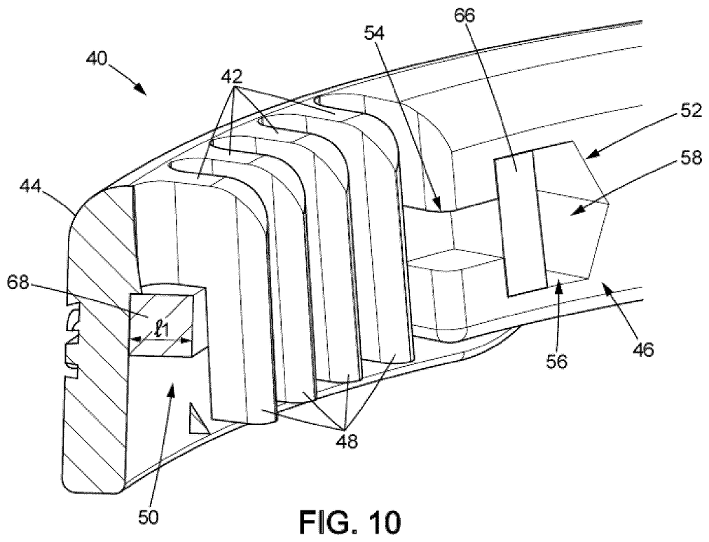

Here each nub 42 forms a tooth 48 extending parallel to the axis of rotation X. Here the teeth 48 extend downward when the eyeglasses 10 are worn. All the teeth 48 are parallel to each other, such that the teeth 48 delimit a channel 50 extending along the longitudinal direction of the temples 14. The channel 50 is open parallel to the inner surface 46 of the flexible portion 40 (here downward), for receiving a longitudinal body 68 of an elastic insert 62 by push fitting as shown on FIGS. 7 to 10.

The elastic insert 62 is made of a flexible material, in particular an elastomer.

The longitudinal body 68 may have a rectangular section, here a square section, but any other section is conceivable. The longitudinal body 68 is inserted into the channel 50 (here from the bottom) to rest on the bottom of the channel 50 by being retained by the teeth 48. The channel 50 may have a width (perpendicular to the inner surface 46) corresponding to the width l1 of the longitudinal body 68 to receive it substantially without play.

The channel 50 defined by the teeth 48 may be extended on either side of the flexible portion 40 by two slots 54 arranged in the corresponding temple 14 (see FIGS. 4 to 6). Each slot 54 is open towards the inner surface 46 of the flexible portion 40 (meaning towards the inside of the eyeglasses 10). The slot 54 is thus suited for retaining the longitudinal body 68 parallel to the aforementioned inner surface 46. The slot 54 may have a height (parallel to the inner surface 46) corresponding to the height H1 of the longitudinal body 48 to receive it substantially without play.

The end of the slot 54 opposite from the series of nubs 42 opens into the cavity 52 laid out in the temple 14. The cavities 52 are open towards the inner surface 46 of the flexible portion 40 (meaning towards the inside of the eyeglasses 10).

The cavities 52 receive the tenons 64, 66 provided at the opposite ends of the elastic insert 62 by push fitting (see FIGS. 7 to 10). The tenons 64, 66 come to bear against the ends of the cavities 52 near the slots 54 for placing the longitudinal body 68 of the elastic insert 62 under tension. This tension leads to an elastic stress on the temples 14 towards each other, substantially in rotation around the axis of rotation X.

The tenons 64, 66 have a height H1 measured parallel to the inner surface 46 which is greater than the height H2 of the longitudinal body 68. Each cavity 52 may have the same height H1 as the tenons 66, 68 so as to receive the tenons 66, 68 substantially without play in height (meaning parallel to the axis of rotation X).

As clearly seen on FIGS. 4 to 6, each cavity 52 may extend on either side of the corresponding slot 54 by grooves 61 parallel to the inner surface 46, delimited between the outer wall 44 and the edges 60 of the temple 14.

These grooves 61 receive shoulders 70 of the tenons 64, 66 with corresponding shape by push fitting (FIGS. 7 to 10), so as to retain the tenons 64, 66 in the cavities 52 perpendicularly to the inner surface 46.

An opening 63 extending parallel to the axis of rotation X may be formed in the temple 14 near each cavity 52 in order to allow the molding of the grooves 61.

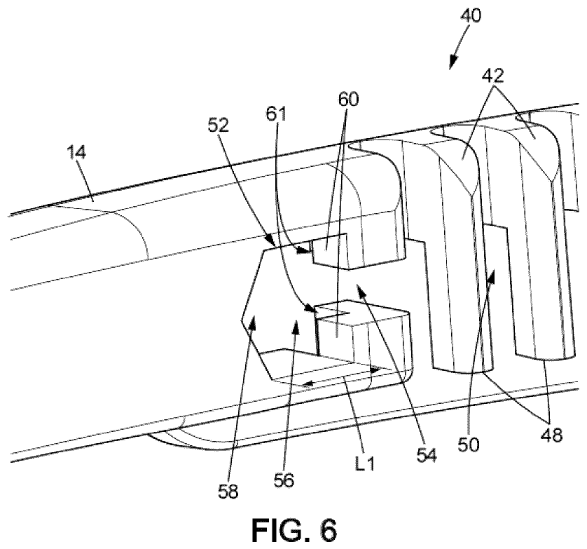

As shown in FIG. 6 to 10, each cavity 52 may have a main part 56 in which the corresponding tenon 64, 66 may slide along the longitudinal direction of the temple 14. This part 56 has a length L1, along the longitudinal direction of the temple 14, which is greater than or equal to the length L2 of the tenon 64, 66 (including shoulder 70), so as to allow the placement of the tenon 64, 66 in the cavity 52 during mounting of the elastic insert 62 or the extraction thereof from the cavity 52 during removal of the elastic insert 62 for example in order for the replacement thereof.

When the elastic insert 62 is mounted, a portion of the cavity 52 opposite the slot 54 is therefore left free. This free portion allows not only the translational movement of the tenon 64, 66 for releasing the shoulder 70, but may also allow inserting a tool under the tenon 64, 66 to make its extraction easier by a lever effect.

The cavity 54 may comprise an end part 58 which extends the main part 56 opposite from the slot 54 and which makes insertion of such a tool easier. This end part 58 could have a pointed shape converging away from the slot 54.

A length of the elastic insert 62 measured along the longitudinal direction of the temple 14 may be included between 20 and 30 mm. However, any other length of the elastic insert 62 could be considered. The length of the elastic insert 62 may be selected to adjust the stress applied to the flexible portion 40 of the frame front 12 by the elastic insert 62.

The elasticity of the elastic insert 62 may also be selected to adjust the stress applied to the flexible portion 40 of the frame front 12 by the elastic insert 62.

Thus, in particular when several types of elastic inserts 62 (different lengths and/or elastic properties) are available, it is possible to adjust the tightness of the temples 14 on the head of the user for optimizing the comfort of wearing the eyeglasses and/or their hold. The elastic insert 62 could be replaced, in particular if the user wants to change the type of use of the eyeglasses (for example recreation/sport) or wishes to change the tightness of the temples 14 for any other reason, or even for replacing aging elastic inserts 62 with new elastic inserts 62.

1. Eyeglasses with elastic hinges comprising two temples and a frame front which can bear lenses, where each temple extends along a longitudinal direction between a distal end far from the frame front and a proximal end connected to the frame front, and where the proximal end of the frame front comprises a flexible portion which has an inner surface arranged for being oriented towards the head of a user when the eyeglasses are worn, the eyeglasses further comprise, for each temple, an elastic insert which is removably attached near the inner surface of the flexible portion, wherein said elastic insert determines the tightness of the temples on the head of the user when the eyeglasses are worn.

2. The eyeglasses according to claim 1, wherein the elastic insert is attached by press fitting in said flexible portion of the temple

3. The eyeglasses according to claim 1, wherein the elastic insert comprises a first tenon a second tenon and a longitudinal body extending between the first tenon and the second tenon, wherein the first and second tenons are press fitted in either side of the flexible portion so as to be able to exert traction on the longitudinal body when the temples are separated from each other.

4. The eyeglasses according to claim 3, wherein the first and second tenons are press fitted in cavities formed in the flexible portion.

5. The eyeglasses according to claim 4, wherein the cavities are open towards the inner surface of the flexible portion.

6. The eyeglasses according to claim 5, wherein each tenon comprises at least one shoulder extending towards the longitudinal body, engaged in a groove extending the corresponding cavity under a ledge of the corresponding temple.

7. The eyeglasses according to claim 6, wherein portion of each cavity is left free by the tenon so as to allow a sufficient displacement of the tenon in the cavity for freeing said shoulder from the corresponding groove.

8. The eyeglasses according to claim 4, wherein near each cavity the longitudinal body is received in a slot, where said slot is open towards the inner surface of the flexible portion, and where said slot extends along the longitudinal direction.

9. The eyeglasses according to claim 1, wherein the flexible portion comprises an outer wall and a series of nubs projecting from said outer wall towards the inner surface, where said nubs are aligned along the longitudinal direction and respectively form teeth which extend parallel to the inner surface to delimit a channel, and where the insert can be press fitted in said channel.

10. The eyeglasses according to claim 9, wherein all the teeth extend in the same direction, and the channel is open parallel to the inner surface.
